(19) United States
(12) Patent Application Publication
(10) Pub. No.: US 2021/0252427 A1
(43) Pub. Date: Aug. 19, 2021

(54) Drying Device and Drying System

(71) Applicant: MANN+HUMMEL GmbH, Ludwigsburg (DE)

(72) Inventors: Alexander Traut, Bad Rodach (DE); Marius Panzer, Ludwigsburg (DE)

(21) Appl. No.: 17/194,716

(22) Filed: Mar. 8, 2021

Related U.S. Application Data
(63) Continuation of application No. PCT/EP2019/072002, filed on Aug. 16, 2019.

(30) Foreign Application Priority Data
Sep. 11, 2018 (DE) 10 2018 122 071.5

(51) Int. Cl. B01D 17/02; B01J 20/18; B01D 17/12

(52) U.S. Cl. CPC B01D 17/0202; B01J 20/183; B01D 2257/80; B01D 2221/08; B01D 17/12

(57) ABSTRACT

A drying device for removal of water at least from a liquid is provided with a connection head to be connected to a housing wall of a device for receiving the liquid. Dryer modules each containing a drying agent are provided. The dryer modules are connected by an articulated connection to each other, respectively. The dryer modules include a first dryer module and a last dryer module, wherein the last dryer module has at least two rotatory degrees of freedom relative to the first dryer module and/or relative to the connection head. Drying systems are provided with such a drying device to remove water from a liquid.

### CROSS-REFERENCE TO RELATED APPLICATIONS

This application is a continuation application of international application No. PCT/EP2019/072002 having an international filing date of 16 Aug. 2019 and designating the United States, the international application claiming a priority date of 11 Sep. 2018 based on prior filed German patent application No. 10 2018 122 071.5, the entire contents of the aforesaid international application and the aforesaid German patent application being incorporated herein by reference.

### TECHNICAL FIELD

The invention concerns a drying device for removal of water from a fluid, in particular oil, with at least two dryer modules containing drying agent that are connected in an articulated manner to each other. Moreover, the invention concerns drying systems with a drying device.

### BACKGROUND OF THE INVENTION

In fluid-conducting systems, it may happen that water collects in the fluid due to various processes. The water can reach the system, for example, by air exchange with the environment and collect in the fluid. Likewise, free water can be introduced into the system from the environment. Moreover, the water can be produced as a reaction or combustion product. The water can be present in the fluid as free or dissolved water. The water in the fluid can cause undesirable effects such as, for example, corrosion of fluid-conducting components of the system, an increase or decrease of the electrical conductivity of the fluid and/or a reduction of the service life of the fluid, i.e., a shortening of service intervals. At low temperatures, ice crystals may form that block the system.

U.S. Pat. No. 3,951,812 A discloses a water-absorbing device for an oil tank. The device comprises a flat bag of porous fiber material. The bag forms a row of pockets that are separated from each other by a transversely extending line of water-soluble adhesive. The separation lines between the pockets extend parallel to each other. In this way, the bag can be folded so that the pockets come to rest on each other. This enables a space-saving packaging of the device after manufacture. The pockets contain Sterculia Lychnophora Hance in powder form, a water absorbing material of plant origin. In the pockets, elongate sinker weights are arranged which are held diagonally in the bag by a string. The sinker weights cause the bag to sink to the bottom of the oil tank. The device is fastened at a cover of an opening of the oil tank by a securing line that carries a magnet.

U.S. Pat. No. 4,419,236 describes a device absorbing water from the bottom of a tank. The device comprises an envelope of porous cover material. The envelope contains a water-absorbing, but not oil-absorbing, material. The envelope is divided into several pockets by seams that extend parallel to each other. In each pocket, a weight piece is arranged so that the device sinks to the bottom of the tank. The device comprises a line that extends up to an opening of the tank when the device is lying on the bottom of the tank. The line serves for removal of the device from the tank.

### SUMMARY OF THE INVENTION

It is object of the invention to provide a drying device for removal of water from a fluid that enables a flexible utilization of small installation spaces in a fluid-conducting system for effective removal of water from the fluid.

The object is solved by a drying device for removal of water at least from a liquid, in particular oil, with a connection head that is connectable to a housing wall of a device for receiving the liquid, preferably detachably connectable, and with at least two dryer modules containing drying agent that are connected in an articulated manner to each other, wherein a last dryer module relative to a first dryer module and/or the connection head comprises at least two rotatory degrees of freedom.

The object is further solved by a drying system for removal of water at least from a liquid, in particular oil, comprising a drying device according to the invention and a device in which the fluid is received, wherein the fluid is a cooling agent or oil, in particular wherein the oil is an electrically nonconducting insulating oil and contains a polyol ester oil, a lubricant oil, a dialcohol, and/or a poly-alpha-olefin.

The object is further solved by a drying system for removal of water at least from a liquid, in particular oil, comprising a drying device according to the invention and a device for receiving the fluid, wherein the device for receiving the fluid comprises an electric motor, a transmission, a fuel cell, a transformer or a rechargeable battery.

The object is further solved by a drying system for removal of water at least from a liquid, in particular oil, comprising a drying device comprising at least two dryer modules containing drying agent, that are connected in an articulated manner to each other, and a device in which the liquid is received, wherein the drying device is arranged such that at least one of the dryer modules is immersed in the liquid and another one of the dryer modules is arranged in a head space above the liquid.

Preferred embodiments are disclosed in the dependent claims and the description.

According to the invention, a drying device for removal of water at least from a liquid fluid, in particular oil, preferably in the form of cooling oil, insulating oil and/or lubricant oil, is provided. The drying device comprises at least two dryer modules containing drying agent. The drying agent can remove water from the fluid and store it. An envelope of the dryer modules can be flowed through at least in sections thereof by the fluid. In this way, the water-containing fluid can contact the drying agent so that the drying agent retains the water in the respective dryer module. The dryer modules are designed such that they are completely immersed and do not float when introduced into the liquid from which they are to remove the water. Preferably, the dryer modules are enveloped on all sides by a material through which the fluid can flow. The dryer modules are connected in an articulated manner to each other. The dryer modules are arranged sequentially. In other words, the dryer modules are arranged in a row one behind the other. A following dryer module is articulated to a preceding dryer module, respectively. A last dryer module comprises relative to a first dryer module and/or to the connection head at least two rotatory degrees of freedom. The last dryer module can thus be pivoted relative to the first dryer module and/or to the connection head about at least two axes. In this way, a particularly great flexibility of the drying device is achieved. This enables to accommodate the drying device even in tight and/or angled installation spaces. In particular, it is made possible by the drying device according to the invention to accommodate particularly large quantities of drying agent in such tight and angled installation spaces. In this way, despite a difficult spatial situation, an efficient drying of the fluid can be effected.

The envelope of the individual dryer modules can be embodied rigid, respectively, e.g., as a fluid-permeable housing. The dryer modules can be designed round or angular. In addition to a rigid housing body, the envelope of the individual dryer modules can comprise a flexible material, for example, a screen, a fleece (e.g., spunbond or meltblown) and/or a filter medium. The flexible material serves in particular for retaining abraded particles or fragments of the drying agent. The flexible material can be fixedly connected to the housing body, for example, by overmolding the housing body around the flexible material or by welding or gluing.

Alternatively, the flexible material can be designed as a component separate from the housing body. In particular, the flexible material can form drying agent bags in which drying agent is accommodated, respectively. Each dryer module can then comprise a rigid housing body and a drying agent bag arranged therein and containing drying agent. A housing body can comprise a fill opening for drying agent or drying agent bags.

As an alternative, the envelope of the individual dryer modules can be embodied flexibly, respectively. The envelope of the dryer modules can comprise, for example, a filter medium, a screen fabric and/or a fleece material, e.g., a nonwoven, spunbond and/or meltblown. In particular, the dryer modules can be formed of a hose of the flexible material of the envelope filled with the drying agent. Dryer modules with a flexible envelope also exhibit a certain stiffness, not least due to the contained drying agent. In particular, the filled dryer modules are deformable only to a limited extent. In contrast thereto, the connections between the dryer modules have no or only a very minimal stiffness across a large range of the rotatory relative movement. In this respect, even in case of dryer modules that are to a certain degree flexible, one can speak of degrees of freedom between the dryer modules, wherein in particular the term of degree of freedom is used as if the dryer modules were rigid bodies. The—typically minimal—inherent deformation of the dryer module is not to be understood in the context of the present invention as a degree of freedom between two dryer modules. Instead, also deformable or deformed dryer modules are to be viewed as rigid bodies for the consideration of the degrees of freedom between the dryer modules. In this context, in particular their undeformed state can be considered in order to consider the rotatory relative movements. The drying device can thus be understood as a flexible multi-body system wherein the rotatory degrees of freedom provided according to the invention between the dryer modules correspond to rotatory degrees of freedom of the rigid body movement while degrees of freedom of the inherent deformation of the bodies are not to be taken into account in the present invention.

The wording “removal of water from the fluid” and “drying of the fluid” are used synonymously in the context of the present invention. The fluid to be dried is typically a liquid that also in the “dry” state, i.e., free of water, is present in the liquid aggregation state.

Preferably, it is provided that the drying device comprises at least three dryer modules containing drying agent and that a first pivot axis between the first dryer module and the immediately following dryer module is not aligned parallel to a second pivot axis between the last dryer module and the immediately preceding dryer module. In this way, the at least two rotatory degrees of freedom of the last dryer module relative to the first dryer module can be particularly easily established. In particular, the first pivot axis can be oriented perpendicularly to the second pivot axis. The drying device can comprise more than three dryer modules. Preferably, pivot axes are then embodied between respective immediately sequentially arranged dryer modules, wherein the respective sequentially arranged pivot axes are not parallel but perpendicularly oriented relative to each other. In this manner, a particularly flexible drying device can be obtained.

In a drying device with at least three dryer modules, two immediately sequentially arranged dryer modules can have precisely one rotatory degree of freedom relative to each other. This further simplifies the configuration of the drying device.

Two immediately sequentially arranged dryer modules can comprise at least two, preferably three, rotatory degrees of freedom relative to each other. In this way, the flexibility and adaptational ability of the drying device is further improved. An envelope of all dryer modules can be designed as one piece, wherein the envelope in the region of each of the dryer modules at least in sections thereof can be flowed through by the fluid. For an articulated connection with two or three degrees of freedom between two neighboring dryer modules, the one-piece envelope between these dryer modules can be pulled together approximately to a point, for example, can be tied together.

Two immediately sequentially arranged dryer modules can be connected to each other by a ball joint. Moreover, the connection head can be connected to the first dryer module by means of a ball joint. In this way, a third rotatory degree of freedom is established between the immediately sequentially arranged dryer modules for a further increased flexibility of the drying device. Furthermore, ball joints can be manufactured easily. The drying device can be produced economically, in particular with respect to joining the dryer modules.

Two immediately sequentially arranged dryer modules can be connected to each other in that a hook element of one of the dryer modules engages an eye element of the other dryer module. In this way, two rotatory degrees of freedom can be established between immediately sequentially arranged dryer modules in a particularly simple way. Moreover, connection head and first dryer module can be coupled by a hook element and an eye element.

Particularly preferred, it is provided that each of the dryer modules at one end has a first connection element and at the other end a second connection element, wherein the first and the second connection elements of two immediately sequentially arranged dryer modules interact with each other, respectively. In this way, the drying device can be adapted in a simple way to the size of the available installation space in that correspondingly many dryer modules, identical relative to each other, respectively, are joined to the drying device. The first and second connection elements can be advantageously embodied, for example, as ball heads or joint sockets of a ball joint or as hook or eye elements.

A drying device in which an envelope of all dryer modules is embodied as one piece is also particularly preferred. This enables a particular easy manufacture of the drying device. The fluid can flow through the envelope in the region of each of the dryer modules at least in sections. Preferably, the articulated connection between two immediately sequentially arranged dryer modules is embodied as a film hinge in the envelope. Such a film hinge can be manufactured in an economical manner. In addition, the film hinge forms a separation between respective neighboring dryer modules. The envelope of the dryer modules can comprise, for example, a filter medium, a screen fabric and/or a fleece material, e.g., a nonwoven, a spunbond and/or a meltblown. The axes of the film hinges of two neighboring dryer modules can be displaced relative to each other by 90°, respectively. In this manner, in case of at least three dryer modules, the first and the last dryer module have two rotatory degrees of freedom relative to each other.

The one-piece envelope can be manufactured from a hose whose hose wall in the region of the articulated connection between two immediately sequentially arranged dryer modules is contracted along the pivot axis between these dryer modules. This enables an economic manufacture. In particular, without greater modifications, drying devices with a different number of dryer modules can be manufactured. Oppositely positioned sections of the hose wall can be connected to each other along the respective pivot axis by material fusion. In particular, the oppositely positioned sections of the hose wall along the respective pivot axis can be welded or glued to each other. Alternatively, the oppositely positioned sections of the hose wall can be sewn together along the respective pivot axis.

The drying agent can comprise an adsorber material. Advantageously, the drying agent can comprise a molecular sieve, preferably a zeolite molecular sieve. Silica gels are suitable in particular for drying air and fluids with high concentrations of dissolved water. Molecular sieves are used advantageously for low concentrations of dissolved water in the fluid. Silica gels can indicate an exhaustion of the water absorption capacity by color change. For this purpose, cobalt chlorite and/or methyl violet (orange gel) can be used as color indicator, for example. The adsorber material can comprise a framework silicate. The drying agent can comprise various types of zeolite molecular sieves. The drying agent can comprise natural or synthetic zeolites. Silica gel can be present in the form of alumino silicate. The drying agent can comprise bentonite/clay minerals, for example, containing aluminum oxide, calcium sulfate, calcium carbonate; the aforementioned drying agents can be regenerated. Also, the drying agent can comprise bentonite/clay minerals that cannot be regenerated, for example, containing calcium, calcium hydride, calcium oxide, calcium sulfate, potassium hydroxide, copper sulfate, lithium aluminum hydride and/or sodium hydroxide.

The molecular sieves for adsorption of water comprise typically a mesh width (pore size) of 3 to 4 angstrom. The silica gels can comprise an average pore size of 25 nm or 65 nm.

The drying agent, in particular in the form of zeolite molecular sieves, can be present as a powder, for example, with an average particle size of 5 μm to 10 μm (pure form of zeolite). Alternatively or additionally, the drying agent, in particular in the form of zeolite molecular sieves, can be present in a bead shape (e.g., 0.1 mm to 50 mm in diameter), in rod shape, as hollow fiber membrane, as mixture of polymer and drying agent, in moldings, as solid body and/or as shaped body (in particular of composite material), preferably with a sponge or honeycomb structure.

It can be provided that the first dryer module contains a first drying agent and that the second dryer module contains a second drying agent. The first dryer module contains thus a different drying agent than the last dryer module. Preferably, the first dryer module comprises an adsorber material for adsorption of water from air, e.g., a silica gel, and the last dryer agent a molecular sieve, e.g., a zeolite molecular sieve. Advantageously, when using the drying device, the last dryer module, preferably containing a molecular sieve, is immersed in the fluid to be dried while the first dryer module, preferably containing a silica gel, is arranged in a head space above the fluid. In this way, the air above the fluid can be dried (dehumidified), and the fluid itself can be dried at the same time.

The drying device comprises a connection head that can be attached to a housing wall of a device for receiving the fluid, preferably detachably. By means of the connection head, the drying device can be connected at a suitable location at the housing wall. In particular, the connection head can be embodied for attachment in an opening in the housing wall. In particular, the connection head can be screwed into the opening of the housing wall. The connection head can comprise an outer thread for this purpose. A sealing element can be arranged at the connection head, in particular wherein the sealing element is an O-ring, a shaped seal and/or a flat seal. The sealing element can comprise, alternatively or additionally, a sealing lip. The sealing element can be embodied as a two-component seal. Typically, the sealing element is held at the connection head by form fit, for example, in a groove, so that it can be exchanged together with the dryer cartridge. Alternatively, the sealing element can be injection molded to the connection head. The connection head can comprise a connection opening through which fluid can be guided to the dryer modules. Advantageously, the connection head and the uppermost dryer module can comprise means for releasable connection of the dryer modules to the connection head. In particular, the connection is designed to be rotatable, for example, in the form of hook and eye or with elements of a ball joint. This configuration enables producing a rotatory degree of freedom between connection head and uppermost dryer module.

The present invention also encompasses a drying system for removal of water from a fluid, in particular oil. The drying system comprises a drying device as described above and a device in which the fluid is received. The fluid is an electrically nonconducting insulating oil, in particular wherein the insulating oil contains a polyol ester oil and/or a poly-alpha-olefin. For insulating oils, the removal of dissolved or free water is particularly important in order to maintain the insulation properties of the insulating oil. Insulating oils are used, for example, in electrical devices such as transformers, capacitors and/or batteries/rechargeable batteries. The insulating oil can act at the same time as cooling oil for heat dissipation.

The fluid of such a drying system can alternatively or additionally comprise dialcohol. The fluid can be moreover a cooling agent, for example, halogenated or non-halogenated hydrocarbons, in particular hydrofluorocarbon or hydrofluoroether.

The invention concerns moreover a drying system for removal of water from a fluid, in particular oil, comprising an above-described drying device and a device for receiving the fluid. The device for receiving the fluid can comprise an internal combustion engine, an electric motor, a transmission and/or a braking system. The device for receiving the fluid comprises a fuel cell, a transformer, and/or a rechargeable battery. In these devices, drying of the fluid in the device is particularly important. The aforementioned devices can be, for example, a part of a motor vehicle or can be designed otherwise to be mobile. The device for receiving the fluid can comprise a locomotive or a rail car. The device for receiving the fluid can comprise a buffer battery that can serve, for example, for intermediate storage of regeneratively generated electrical energy and its supply into a power network. The fluid is typically a cooling liquid, in particular a cooling oil or a cooling agent. The fluid can exhibit at the same time electrically insulating properties of an insulating oil.

Finally, the invention concerns a drying system for removal of free or dissolved water from a fluid, in particular oil, comprising a drying device with at least two dryer modules containing drying agent, which are connected to each other in an articulated manner, and further comprising a device in which the fluid is received. At least one of the dryer modules is immersed in the fluid and another one of the drying modules is arranged in a head space above the fluid. In this way, the air above the fluid can be dried (dehumidified), and the fluid itself can be dried at the same time. For this purpose, the drying system comprises preferably two different drying agents. Typically, the dryer module that is not immersed in the fluid contains a silica gel. The dryer module that is immersed in the fluid contains a porous crystalline adsorber material for adsorption of water, typically a molecular sieve, in particular a zeolite molecular sieve. When the drying device comprises more than two dryer modules, at least two dryer modules are typically immersed in the fluid. In particular, advantageously approximately two thirds of the dryer modules, containing preferably a molecular sieve, respectively, in particular a zeolite molecular sieve, can be immersed in the fluid and a third of the dryer modules, preferably containing a silica gel, respectively, can be arranged in the head space above the fluid.

The drying systems can each comprise a moisture sensor, in particular a capacitive moisture sensor. It can measure the moisture (the water content) of the fluid. In this way, it can be detected when the water absorption ability (water absorption capacity) of the drying agent is exhausted and a satisfactory drying of the fluid no longer occurs. Alternatively or additionally, the drying system can comprise an inspection glass in which a color change takes place when the water content of the fluid surpasses a limit value.

The various aspects of the afore described drying systems can be combined with each other, respectively.

The drying device can be part of a thermal management module. The module comprises: a container, in particular compensation container, for receiving the liquid; a drying device which is inserted into the container; at least one filter or screen; a pump; at least one sensor for determining at least one process parameter, for example, temperature and/or moisture and/or pressure; and a cooling device. The module can be coupled to different types of consumers, for example, a transmission, a battery, a rechargeable battery, transformer, electric motor, an internal combustion engine, a braking system or power electronics.

### BRIEF DESCRIPTION OF THE DRAWINGS

Further features and advantages of the invention result from the following detailed description of embodiments of the invention, from the claims as well as based on the Figures of the drawing showing details according to the invention.

The aforementioned and still to be described features can be realized individually on their own, respectively, or several combined in any combinations in variants of the invention. The features disclosed in the drawing are illustrated such that the particularities according to the invention can be made clearly visible.

FIG. 1a shows a drying device with four dryer modules that are connected to each other by hook and eye elements, in a schematic perspective view.

FIG. 1b shows the drying device of FIG. 1a in a schematic side view.

FIG. 2a shows a drying device with four dryer modules that are connected to each other by ball joints, in a schematic perspective view.

FIG. 2b shows the drying device of FIG. 2a in a schematic side view.

FIG. 3 shows a drying device with four dryer modules that comprise as a whole a one-piece envelope, wherein between neighboring dryer modules film hinges are formed in the envelope, in a schematic perspective view.

FIG. 4 shows a drying system with a drying device with five dryer modules of which four are immersed in a fluid, in a schematic side view.

### DESCRIPTION OF PREFERRED EMBODIMENTS

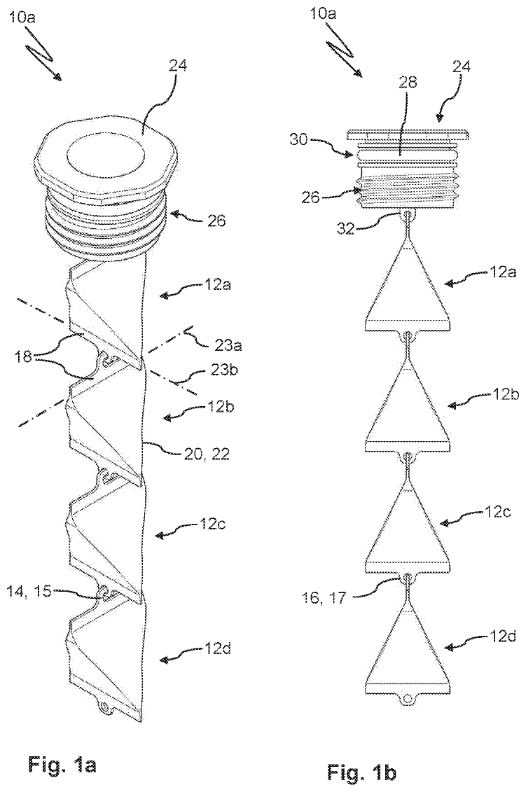

FIG. 1a shows a drying device 10a in a perspective view. In FIG. 1b, the drying device 10a of FIG. 1a is illustrated in a side view. The drying device 10a serves for removal of water from a fluid that is preferably present in the form of oil. The drying device 10a comprises four dryer modules 12a-12d. The dryer modules 12a-12d contain each a drying agent, not illustrated in detail. The drying agent is here a zeolite molecular sieve, respectively. As an alternative, in particular the dryer module 12a, in case that in operation it is arranged in a space above the liquid that is generally filled with air, can contain a silica gel as drying agent for removal of water from the air.

The dryer modules 12a-12d are respectively connected in an articulated manner to each other. For this purpose, each one of the dryer modules 12a-12d comprises at the upper end a hook element 14 and at the lower end an eye element 16. Thus, each one of the dryer modules 12a-12d comprises at one end a respective same-type first connecting element 15 and, at the other end, a respective second connecting element 17 that is of the same type among the dryer modules 12a-12d. A first connecting element 15 is coupled respectively with a second connecting element 17 in order to provide an articulated connection of the respectively coupled dryer modules 12a-12d. The eye element 16 of one of the dryer modules 12a-12c is engaged respectively by the hook element 14 of the dryer module 12b-12d that is arranged immediately underneath. In this way, it is provided that two immediately adjacently arranged dryer modules 12a-12d each have two rotatory degrees of freedom relative to each other. In particular, the last dryer module 12d has at least two rotatory degrees of freedom relative to the first dryer module 12a.

The hook elements 14 and the eye elements 16 are formed here at upper or lower strips 18 of the dryer modules 12a-12d, respectively. A housing body 20 of the dryer modules 12a-12d forms a rigid envelope 22, respectively. The envelope 22 which is formed by the housing body 20 can be flowed through by the fluid. The envelope 22, in other words, is permeable for the fluid. In this context, the housing body 20 is embodied as a grid-shaped plastic cage. A mesh width of the grid-shaped plastic cage is selected to be so small, here approximately 100 μm, that the drying agent is retained in the dryer modules 12a-12d. In an embodiment, not illustrated in detail, a filter medium with a still smaller pore size of, for example, approximately 20 μm, can be arranged at the inner and/or outer side at the housing body 20. The filter medium can also reliably retain abraded particles and/or fragments of the drying agent.

For forming the strips 18, the plastic cage of the housing body 20 is compressed along the strips and oppositely positioned wall sections are welded to each other. The pivot axis 23a, 23b which can be correlated with the rotatory degrees of freedom between neighboring dryer modules 12a-12d can extend here parallel to the strips 18 of the respective dryer modules 12a-12d through the coupled hook and eye elements 14, 16.

The drying device 10a comprises here moreover a connection head 24. By means of the connection head 24, the drying device 10a can be fastened to a housing wall of a device for receiving the fluid that is not illustrated. The connection head 24 is provided here with an outer thread 26. By means of the outer thread 26 the connection head 24 can be screwed into a corresponding inner thread of an opening in the housing wall (not illustrated). This enables a simple and fast attachment or exchange of the drying device 10a. Above the outer thread 26, a sealing element 28, here an O-ring, can be arranged at the connection head 24. The connection head 24 comprises a groove 30 for receiving the sealing element 28 in which the sealing element 28 is held.

In a further embodiment, not illustrated in detail, the connection head 24 can comprise a connection opening. Through the connection opening, the fluid can be guided to the dryer modules 12a-12d of the drying device 10a or away from the dryer modules 12a-12d. In this way, a targeted inflow to the dryer modules 12a-12d can be realized. This can further improve the drying performance of the drying device 10a. The connection opening can be embodied here as a through cutout in the connection head 24 wherein the through cutout preferably can be arranged parallel, in particular coaxial, to the outer thread 26.

The connection head 24 comprises a fastening element 32. The fastening element 32 serves for connecting the first dryer module 12a to the connection head 24. The fastening element 32 is embodied here as an eye. The eye of the connection head 24 is preferably of the same kind as the eye elements 16 of the dryer modules 12a-12d. The hook element 14 of the first dryer module 12a engages here the fastening element 32 which is embodied as an eye. In this way, the dryer module 12a is connected in an articulated manner to the connection head 24. In particular, the dryer module 12a has two rotatory degrees of freedom relative to the connection head 24.

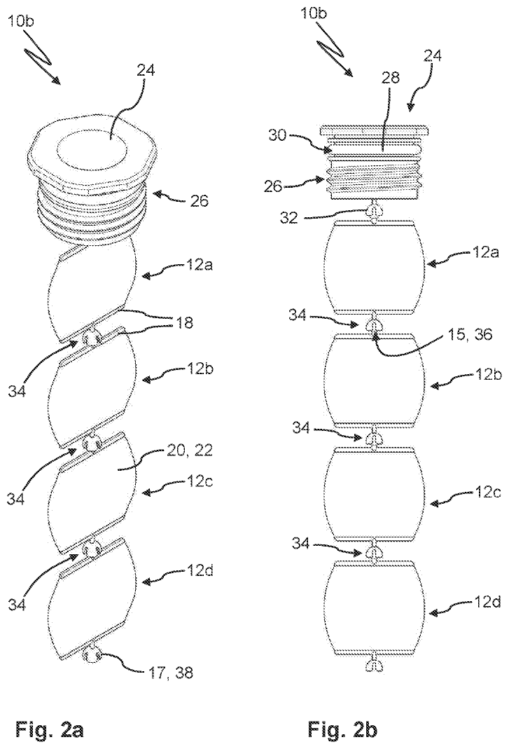

FIG. 2a shows a drying device 10b in a perspective view. In FIG. 2b, the drying device 10b of FIG. 2a is illustrated in a side view. The drying device 10b serves for removing water from a fluid that is preferably present in the form of oil. The drying device 10b comprises four dryer modules 12a-12d. The dryer modules 12a-12d contain respectively a drying agent, not illustrated in detail. The drying agent is here a zeolite molecular sieve, respectively. Alternatively, in particular the dryer module 12a, in case that in operation it is arranged in a space above the fluid that is generally filled with air, can contain a silica gel as a drying agent for removal of water from the air.

The dryer modules 12a-12d are connected to each other in an articulated manner, respectively. For this purpose, between two immediately adjacently arranged dryer modules 12a-12d, a ball joint 34 is provided, respectively. Due to the connection by means of the ball joint 34, neighboring dryer modules 12a-12d each have three rotatory degrees of freedom relative to each other. In particular, the last dryer module 12d has three rotatory degrees of freedom relative to the first dryer module 12a.

The ball joints 34 are formed by a ball head 36 and a joint socket 38, respectively. The ball head 36 and the joint socket 38, as first and second connecting elements 15, 17, are arranged at one end and the other end at the dryer modules 12a-12d, respectively. The joint sockets 38 are here embodied slotted, beginning at their free end, in order to facilitate insertion (locking) of the correlated ball head 36. In the mounted state, the ball heads 36 are held with form fit in the joint sockets 38, respectively.

The first and second fastening elements 15 and 17 are arranged in the drying device 10b at upper or lower strips 18 of the dryer modules 12a-12d. The strips 18 form each a termination at the top or bottom of an envelope 22 of the dryer modules 12a-12d. The envelope 22 is here formed by a rigid housing body 20, for example, of a perforated plastic material. Alternatively, the envelope 22 can be formed of an in particular flexible fleece material that is connected to the strips 18 (not illustrated in detail).

The drying device 10b comprises a connection head 24. The first dryer module 12a is fastened to the connection head 24. Here, the dryer module 12a is connected to the connection head 24 in an articulated manner. The connection head 24 comprises a fastening element 32 in the form of a joint socket which is engaged by the ball head 36 of the dryer module 12a. In this way, the dryer module 12a has three rotatory degrees of freedom relative to the connection head 24. In other respects, the connection head 24 of the drying device 10b corresponds to the connection head 24 of the drying device 10a of FIGS. 1a, 1b.

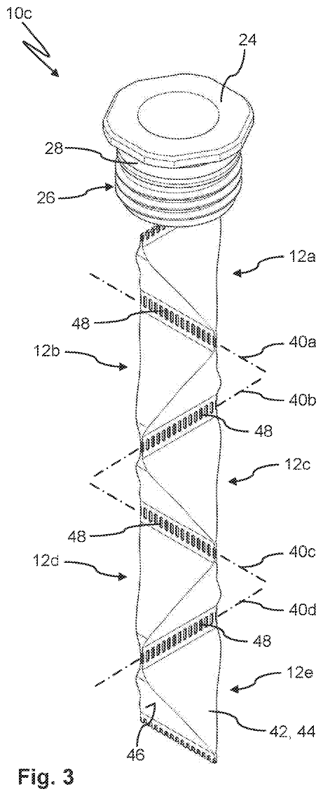

FIG. 3 shows a drying device 10c in a perspective view. The drying device 10c serves for removal of water from a fluid that is preferably present in the form of oil. The drying device 10c comprises five dryer modules 12a-12e. The dryer modules 12a-12e contain each a drying agent, not illustrated in detail. The drying agent is here a zeolite molecular sieve, respectively. As an alternative thereto, in particular the drying module 12a, in case that in operation it is arranged in a space above the liquid that is generally filled with air, can contain a silica gel as drying agent for removal of water from the air.

The dryer modules 12a-12e are each connected in an articulated manner to each other. Here, two dryer modules 12a-12e immediately neighboring each other comprise each precisely one rotatory degree of freedom relative to each other. One pivot axis 40a-40d between two neighboring dryer modules 12a-12e is correlated with this rotatory degree of freedom, respectively. Immediately sequentially arranged pivot axes 40a-40d do not extend parallel but here perpendicularly to each other. In particular, the pivot axis 40a between the first dryer module 12a and the immediately sequentially arranged dryer module 12b extends here perpendicularly to the pivot axis 40d between the last dryer module 12e and the immediately preceding dryer module 12d. It should be noted that one or several further dryer modules can adjoin the last dryer module 12e (not illustrated). The “last” dryer module 12e is then not the last dryer module of the drying device in the meaning of the word. In this meaning, the dryer module 12c could presently also be referred to as the last dryer module of the drying device 10c.

An envelope 42 of all dryer modules 12a-12e is embodied here as one piece. The envelope 42 is formed by a hose 44 with a hose wall 46 through which the fluid can flow. The articulated connection between neighboring dryer modules 12a-12e is embodied as a film hinge 48 in the envelope 42. For forming the film hinge 48, the hose wall 46 in the region of the respective pivot axes 40a-40d is pulled together and oppositely positioned sections of the hose wall 46 are connected to each other along the respective pivot axis 40a-40d, here welded together, in particular fused to each other by an ultrasonic method. Due to the weld seams which form the film hinges 46, the interior spaces of neighboring dryer modules 12a-12e are separated from each other.

The hose 44 is made here of a flexible filter medium. The filter medium is preferably a cellulose-free synthetic filter medium. The individual dryer modules 12a-12e are here not inherently rigid but exhibit a certain deformability. The inherent deformability of the dryer modules 12a-12e is however minimal in relation to the pivotability of the dryer modules 12a-12e relative to each other.

The drying device 10c comprises a connection head 24. The dryer module 12a is fastened in an articulated manner at the connection head 24. For this purpose, the connection head 24 can comprise a fastening element in the form of an eye, compare FIG. 1b. Correspondingly, a coupling element, here a hook for engaging the eye, can be formed at the first dryer module 12a. The coupling element can be embodied as one piece together with the envelope 42. Preferably, the coupling element is embodied as a component separate from the envelope 42 and is connected to the envelope, for example, is welded or glued to the envelope 42.

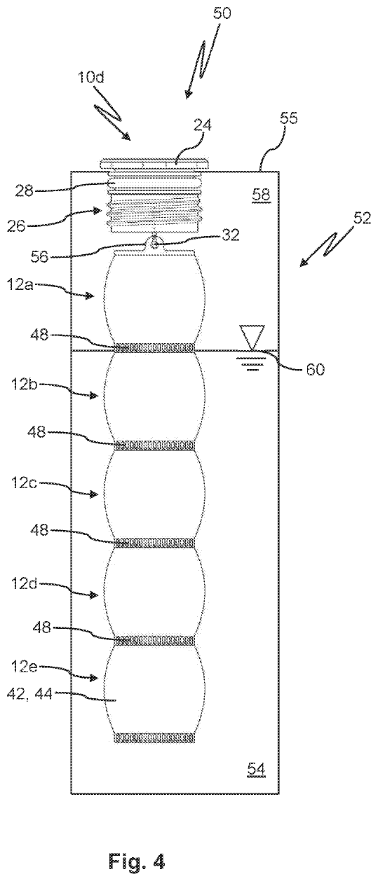

FIG. 4 shows a drying system 50. The drying system 50 comprises a drying device 10d. The drying device 10d comprises five dryer modules 12a-12e. The dryer modules 12a-12e are connected in an articulated manner to each other, respectively. An envelope 42 of the drying device 10d is embodied as a whole as one piece, as in the drying device 10c of FIG. 3. Here, the pivot axes between neighboring dryer modules 12a-12e each are embodied so as to extend parallel to each other as film hinges 48 in the envelope 42. Alternatively, the drying system 50 can comprise a drying device 10a, 10b or 10c, as they have been described above and are shown in FIGS. 1a to 3.

The drying system 50 comprises moreover a device 52 in which the fluid 54 is received. The device 52 in which the fluid 54 is received is illustrated here only schematically as a compensation tank. The drying system 50 comprises here, in addition to the compensation tank and the drying device 10d, an electrical device, namely a rechargeable battery (not illustrated here). The rechargeable battery serves as a buffer battery for intermediate storage of regeneratively produced electrical energy and its supply to a power network, for example, of a residential building. The fluid 54 is here an electrically nonconducting insulating oil which is used for cooling the electrical device, i.e., here the rechargeable battery. The insulating oil can contain in particular a polyol ester oil and/or a poly-alpha-olefin. The drying device 10d serves for removal of water, which can be contained as dissolved and/or free water in the fluid 54.

The drying device 10d comprises a connection head 24. The connection head 24 is screwed into an opening in a housing wall 55 of the device 50 (only schematically illustrated). The dryer module 12a is connected in an articulated manner to the connection head 24. The connection head 24 comprises for this purpose a fastening element 32 in the form of a hook that is interacting with a coupling element 56, here an eye, of the first dryer module 12a; here, the hook engages the eye. In other respects, the connection head 24 can be embodied as described in regard to FIGS. 1a, 1b.

The dryer modules 12b-12e are immersed in the fluid 54. They contain a zeolite molecular sieve as drying agent for drying the fluid 54. The dryer module 12a is arranged in a head space 58 above the fluid 54. The fluid level 60 is located here between the dryer modules 12a and 12b. The dryer module 12a contains a silica gel as drying agent for drying the air.

What is claimed is:

1. A drying device for removal of water at least from a liquid, the drying device comprising:
a connection head configured to be connected to a housing wall of a device for receiving the liquid;
dryer modules each containing a drying agent;
wherein the dryer modules are connected by an articulated connection to each other, respectively;
wherein the dryer modules include a first dryer module and a last dryer module, wherein the last dryer module comprises at least two rotatory degrees of freedom in relation to the first dryer module and/or in relation to the connection head.

2. The drying device according to claim 1, wherein the dryer modules include a second dryer module immediately sequentially arranged next to the first dryer module, wherein a first pivot axis is provided between the first dryer module and the second dryer module and a second pivot axis is provided between the last dryer module and a preceding dryer module that immediately precedes the last dryer module, wherein the first pivot axis is not parallel to the second pivot axis.

3. The drying device according to claim 2, wherein the first pivot axis is perpendicular to the second pivot axis.

4. The drying device according to claim 1, wherein the dryer modules include two immediately sequentially arranged dryer modules comprising precisely one rotatory degree of freedom relative to each other.

5. The drying device according to claim 1, wherein the dryer modules include two immediately sequentially arranged dryer modules comprising at least two rotary degrees of freedom relative to each other.

6. The drying device according to claim 5, wherein said two immediately sequentially arranged dryer modules are connected to each other by a ball joint forming the articulated connection.

7. The drying device according to claim 5, wherein said two immediately sequentially arranged dryer modules are connected to each other by a hook element provided at one of said two immediately sequentially arranged dryer modules and engaging an eye element provided at the other one of said two immediately sequentially arranged dryer modules, wherein the hook element and the eye element form the articulated connection.

8. The drying device according to claim 1, wherein each one of the dryer modules comprises a first connecting element at a first end and a second connecting element at a second end opposite the first end, wherein the first connecting element and the second connecting element of two immediately sequentially arranged ones of the dryer modules interact with each other, respectively, to form the articulated connection.

9. The drying device according to claim 1, further comprising an envelope enveloping all of the dryer modules, wherein the envelope is embodied as one piece.

10. The drying device according to claim 9, wherein the articulated connection between the dryer modules is a film hinge formed in the envelope, respectively.

11. The drying device according to claim 9, wherein the envelope is a hose comprising a hose wall, wherein the hose wall in a region of the articulated connection between two immediately sequentially arranged ones of the dryer modules is pulled together along a pivot axis between said two immediately sequentially arranged ones of the dryer modules.

12. The drying device according to claim 1, wherein the drying agent comprises a crystalline porous adsorber material.

13. The drying device according to claim 12, wherein the crystalline porous adsorber material is a molecular sieve.

14. The drying device according to claim 13, wherein the molecular sieve is a zeolite molecular sieve.

15. The drying device according to claim 1, wherein the drying agent contained in the first dryer module is a first drying agent for removal of water from air and wherein the drying agent contained in the last dryer module is a second drying agent for removal of water from the liquid, wherein the first and second drying agents are different.

16. A drying system for removal of water at least from a liquid, the drying system comprising:
a drying device according to claim 1; and
a device containing the liquid;
wherein the liquid is a cooling agent or an oil.

17. The drying system according to claim 16, wherein the oil is an electrically nonconducting insulating oil and contains one or more substances selected from the group consisting of a polyol ester oil, a lubricant oil, a dialcohol, and a poly-alpha-olefin.

18. A drying system for removal of water at least from a liquid, the drying system comprising:
a drying device according to claim 1; and
a device configured to receive the liquid;
wherein the device configured to receive the liquid comprises an electric motor, a transmission, a fuel cell, a transformer or a rechargeable battery.

19. The drying system for removal of water at least from a liquid, the drying device comprising:
a drying device comprising dryer modules containing a drying agent and connected by an articulated connection to each other; and
a device containing the liquid;
wherein the drying device is arranged such that at least one of the dryer modules is immersed in the liquid and another one of the dryer modules is arranged in a head space above the liquid.

20. A thermal management module for a transmission, an electric motor, an internal combustion engine, a transformer, a rechargeable battery, a battery or a braking system, the thermal management module comprising a drying device according to claim 1.
